(19) United States
(12) Patent Application Publication
(10) Pub. No.: US 2026/0015835 A1
(43) Pub. Date: Jan. 15, 2026

(54) SYNTHETIC AUDIO FEEDBACK FOR MACHINE IMPLEMENT CONTROL

(71) Applicant: Caterpillar Inc., Peoria, IL (US)

(72) Inventor: David ARSTEIN, Washington, IL (US)

(73) Assignee: Caterpillar Inc., Peoria, IL (US)

(21) Appl. No.: 18/771,808

(22) Filed: Jul. 12, 2024

(51) Int. Cl. E02F 9/26; G10K 15/04

(52) U.S. Cl. CPC E02F 9/268; G10K 15/04

(57) ABSTRACT

With the introduction of electromechanical input devices and sound-proofed cabins, it has become difficult for operators in a cabin to receive audio feedback from a work implement of a work machine. This hinders fine control of the work implement. Accordingly, disclosed embodiments synthetically re-introduce audio feedback into the cabin. In particular, a controller monitors operational parameters associated with movement of the work implement, executes a sound-generation algorithm to convert those operational parameters into audio (e.g., with different audio layers associated with different components of the work implement), and outputs the audio to the operator (e.g., via at least one speaker) in the cabin.

### TECHNICAL FIELD

The embodiments described herein are generally directed to the operation of a work machine, and, more particularly, to synthetic audio feedback during operation of a work implement of the work machine.

### BACKGROUND

When grading a ground surface (e.g., road), accurate blade height is critical. Improper blade height will typically result in decreased productivity, increased wear, the need for rework, increased fuel consumption, and/or the like.

In conventional motor graders, the blade height is determined by hydraulic cylinders that are controlled by the movement of levers within the cabin of the motor grader. The levers are connected, via mechanical linkages, to hydraulic valves that control the flow of hydraulic fluid to actuate the hydraulic cylinders. This configuration provides audible or vibrational feedback to the operator in the cabin.

However, modern motor graders have introduced electromechanical controls, such as joysticks, and improved sound isolation within the cabin. As a result, the sounds and vibrations generated by the hydraulic valves are often imperceptible to the operator in the cabin. Consequently, fine control of the blade can be difficult, especially for operators who are unfamiliar with the “feel” of the electromechanical controls.

In addition, the lack of sound and vibration from the hydraulic valves means that the primary feedback for blade control is visual. This can lead to the operator developing tunnel vision on the blade position, which can result in reduced situational awareness, and/or failing to notice unintentional control inputs.

U.S. Patent Publication No. 2010/0042281 A1 describes a method for providing feedback to a vehicle operator regarding an operational state of a vehicle power transmission system, which includes detecting at least one operational parameter indicative of the operational state, and providing an audio feedback signal to the operator in response to a magnitude of the detected operational parameter. Similarly, U.S. Pat. No. 8,300,844 B2 describes a system for outputting an audible signal that corresponds to an output force generated by a machine against a load. The present disclosure is directed toward overcoming one or more of the problems discovered by the inventor.

### SUMMARY

In an embodiment, a method comprises using at least one hardware processor in a controller within a motor grader to: receive one or more operational parameters, wherein each of the one or more operational parameters represents a position of a respective cylinder of a plurality of cylinders of a work implement of the motor grader, wherein each of the plurality of cylinders is external to a cabin of the work machine, and wherein the position of each of the plurality of cylinders is controlled by at least one input device in the cabin; execute a sound-generation algorithm that converts the one or more operational parameters into audio by, for each of the one or more operational parameters that reflects a change in the position of the respective cylinder, incorporating a synthetic audio layer associated with that respective cylinder into the audio; and output the audio to an operator in the cabin.

In an embodiment, a method comprises using at least one hardware processor in a controller within a work machine to, in real time: receive one or more operational parameters associated with movement of at least one component of the work machine, external to a cabin of the work machine, under control of at least one input device in the cabin; execute a sound-generation algorithm that converts the one or more operational parameters into audio; and output the audio to at least one speaker in the cabin.

In an embodiment, a work machine comprises: a machine body; a cabin comprising at least one joystick and at least one speaker; a work implement comprising a plurality of components; a controller configured to, in real time with movement of one or more of the plurality of components under control of the at least one joystick, receive one or more operational parameters associated with the movement of the one or more components, execute a sound-generation algorithm that converts the one or more operational parameters into audio, wherein the sound-generation algorithm associates each of the plurality of components with an audio layer that is different from the audio layer associated with at least one other one of the plurality of components, and wherein converting the one or more operational parameters into audio comprises incorporating the audio layer associated with each of the plurality of components, for which the one or more operational parameters represent movement, into the audio, and output the audio to the at least one speaker.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates an example work machine, according to an embodiment;

FIG. 2 illustrates example components of a work machine, according to an embodiment;

FIG. 3 illustrates example input devices and associated controls, according to an embodiment;

FIG. 4 illustrates a process for providing audio feedback in a work machine, according to an embodiment; and

FIG. 5 illustrates an example controller for implementing a process for providing audio feedback in a work machine, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details.

In some instances, well-known structures and components are shown in simplified form for brevity of description. For clarity and ease of explanation, some surfaces and details may be omitted in the present description and figures. It should also be understood that the various components illustrated herein are not necessarily drawn to scale. In other words, the features disclosed in various embodiments may be implemented using different relative dimensions within and between components than those illustrated in the drawings.

References herein to “side,” “top,” “bottom,” “front,” “rear,” “above,” “below,” “forward,” “backward,” “left,” “right,” and the like are used for convenience of understanding to convey the relative positions of various components with respect to each other, and do not imply any specific orientation of those components in absolute terms (e.g., with respect to the external environment or the ground). In addition, the terms “respective” and “respectively” signify an association between members of a group of first components and members of a group of second components. For example, the phrase “each component A connected to a respective component B” would signify A1 connected to B1, A2 connected to B2, . . . and AN connected to BN. Also, as used herein, a reference numeral with an appended letter will be used to refer to a specific component, whereas the same reference numeral without any appended letter will be used to refer collectively to a plurality of the component or to refer to a generic or arbitrary instance of the component.

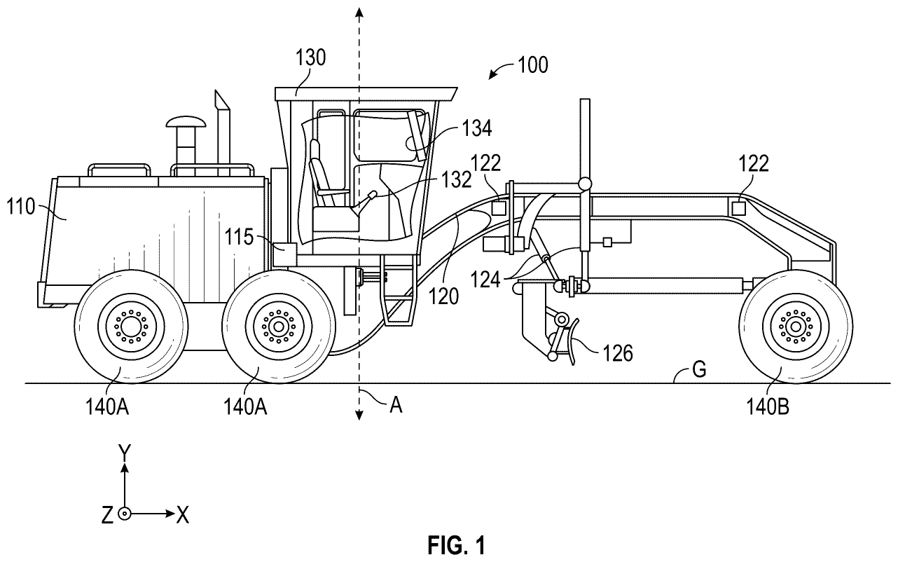

FIG. 1 illustrates an example work machine 100, according to an embodiment. Work machine 100 is illustrated and primarily described herein as a motor grader. However, work machine 100 may be any type of operator-controlled machine, including a wheel loader, dump truck, asphalt paver, backhoe loader, skid steer, track loader, cold planer, compactor, bulldozer, electric rope shovel, forest machine, hydraulic mining shovel, material handler, pipe-layer, road reclaimer, telehandler, tractor-scraper, or the like. In general, the benefits of disclosed embodiments will primarily accrue to work machines 100 with an operator-controlled implement that requires fine control.

As illustrated, work machine 100 may comprise a machine body 110, a work implement 120, a cabin 130 supported by machine body 110, and one or more ground-engaging members 140. Machine body 110 may comprise an internal combustion engine, electric motor (e.g., driven by a battery pack), or the like. Ground-engaging member(s) 140 are configured to move machine body 110 and/or work implement 120 with respect to the ground G. Ground-engaging members 140 are illustrated as wheels, but may comprise other types of components for moving machine body 110 and/or work implement 120 with respect to the ground, such as tracks, rollers, and/or the like. Ground-engaging members 140 may be driven by a drivetrain, which is in turn driven by an internal combustion engine or electric motor within machine body 110. Work machine 100 may comprise ground-engagement members 140A supporting machine body 110 and/or ground-engagement members 140B supporting work implement 120.

Cabin 130 may comprise a seat for the operator, controls, including one or more input devices 132, one or more speakers 134, and/or the like. Input device(s) 132 may comprise a joystick, steering wheel, lever, button, touch sensor (e.g., within a touch-panel display), microphone, and/or the like. Speaker(s) 134 may comprise a dedicated speaker (e.g., mounted within cabin 130), a speaker that is part of another device (e.g., input device 132, such as a joystick, touch-panel display, etc.), earphones (e.g., worn by the operator), and/or the like. Alternatively or additionally, speaker(s) 134 may comprise a haptic motor or other haptic device that outputs haptic or vibrational feedback, in addition to or instead of audio. For instance, the haptic device may be embedded in input device(s) 132 to provide haptic feedback to the operator's hands.

As mentioned above, input device(s) 132 may comprise a joystick. In a preferred embodiment, input device(s) 132 comprise at least two joysticks, such as a right joystick on the right side of the seat and a left joystick on the left side of the seat. Thus, the operator, within the seat, may hold the right joystick with the operator's right hand and the left joystick with the operator's left hand. Each joystick may be configured to move along a single axis (e.g., forward and backward, or left and right), dual axes (e.g., forward and backward and left and right), or triple axes (e.g., forward and backward, left and right, and rotation, within a range of angles, around a longitudinal axis of the joystick). Each joystick may also comprise one or more buttons, triggers, or other inputs that are operable via the operator's fingers and/or thumbs. The operator may move each joystick to control different aspects of work machine 100, as well as interact with the button(s), trigger(s), or other input(s) on each joystick to control further aspects of work machine 100. While the control will primarily be described herein as the movement of one or more components of work implement 120, inputs to input device(s) 132 may, additionally or alternatively, operate other aspects of work machine 100, such as steering, throttle, drive mode, and/or the like.

Components of work implement 120 may be configured to move under control of input device(s) 132. For example, in the context of a motor grader, blade 126 (also known as a “moldboard”) may be configured to rotate within a range of angles in one, two, or preferably three, dimensions, X, Y, and/or Z. The rotation of blade 126 may be controlled by the positions of cylinders 124, which may be actuated by actuators 122, under the control of input device(s) 132.

In the context of an articulated work machine 100, work implement 120 may be configured to articulate within a range of angles around an axis A. Axis A, which is in the Y-dimension, may correspond to a linkage between machine body 110 and work implement 120. The articulation of work implement 120 may be controlled by input device(s) 132.

Work machine 100 may comprise a controller 115 (e.g., within machine body 110, work implement 120, and/or cabin 130), which may be an electronic control unit (ECU). Controller 115 may be communicatively coupled (e.g., via wired or wireless communications) to input device(s) 132 within cabin 130 and to one or a plurality of subsystems of work machine 110, including one or more actuators 122 within work implement 120. Controller 115 may receive control inputs to input device(s) 132 from an operator within cabin 130, and control one or more of actuator(s) 122 of work implement 120 according to the received control inputs. It should be understood that controller 115 may also control the operation of one or more other actuators, components, or subsystems of work machine 100, beyond just actuators 122 of work implement 120.

The control of each actuator 122, by controller 115, may effect movement within a respective component of work implement 120. For example, an actuator 122 may comprise a hydraulic valve that regulates the flow (e.g., generated by a pump) of hydraulic fluid to a hydraulic cylinder 124. The change in hydraulic pressure may cause a piston within hydraulic cylinder 124 to extend from hydraulic cylinder 124 or contract into hydraulic cylinder 124. The piston may be fixed to a portion of a component of work implement 120, such that movement of the piston causes movement of that component. For example, in the context of a motor grader, actuation of a hydraulic cylinder 124 in this manner may cause one or both sides of blade 126 to shift up or down, cause blade 126 to shift left or right, cause blade 126 to pivot around a central axis, or the like.

Controller 115 may also be communicatively coupled to one or more sensors (not shown) within work machine 100. The sensor(s) may include any type of sensor or sensor array capable of measuring values of one or more parameters of one or more subsystems of work machine 100 and/or the external environment of work machine 100. Examples of such parameters include, without limitation, the position of one or more components of work machine 100, engine speed, machine speed, pressure of a fluid (e.g., fuel, oil, coolant, hydraulic fluid, etc.), flow rate of a fluid, temperature of a fluid, contamination level of a fluid, viscosity of a fluid, electric current, electric voltage, state of charge of a battery pack, fluid consumption rates, loading level, transmission output ratio, slip, grade, traction, mileage, time or mileage until or since scheduled maintenance, and/or the like. Of particular relevance to certain embodiments, the sensor(s) may output one or more operational parameters, representing a state, position, audio characteristic, or other attribute of an input device 132, actuator 122, cylinder 124, blade 126, or other component of work implement 120. Examples of such operational parameters include, without limitation, the position of a cylinder 124, an activation of a solenoid valve as an actuator 122, an activation of a relief valve as an actuator 122, a position of a valve as an actuator 122, a position of work implement 120 (e.g., a position of blade 126), a fluid flow, a pressure amount (e.g., hydraulic pressure within a cylinder 124), a control input (e.g., position or movement of an input device 132), a pitch, timbre, frequency, or other audio characteristic of actuator 122, cylinder 124, blade 126, or other component, and the like. In an embodiment in which the operational parameter(s) include an audio characteristic, the sensor(s) may comprise a microphone (e.g., a microphone array) or other audio sensor that is configured to capture sound (e.g., ambient noise) around one or more components of work implement 120, such as actuators 122, cylinder(s) 124, blade 126, and/or the like.

Controller 115 may collect data from input device(s) 132, one or more sensor(s), and/or the like, and process the collected data. Of particular relevance to certain embodiments, the data may comprise one or more operational parameters associated with movement of at least one component of work machine 100, such as actuator 122, cylinder 124, blade 126, and/or the like, under control of input device(s) 132 in cabin 130. For example, each of the operational parameter(s) may represent, or enable the derivation of, a position of a respective cylinder 124 of a plurality of cylinders 124 or other component(s) of work implement 120 of work machine 100 (e.g., a motor grader), and the position of each of these component(s) may be controlled by input device(s) 132 in cabin 130. Notably, the component(s), such as actuator(s) 122 and cylinder(s) 124, may be external to cabin 130 of work machine 100, such that sounds created during movement (i.e., a change in position) of the component(s) may be inaudible, or at least difficult to hear, by an operator within cabin 130.

In an embodiment, controller 115 implements a process, described in greater detail elsewhere herein, that receives the operational parameter(s) associated with movement of component(s) of work machine 100, and executes a sound-generation algorithm that converts the operational parameter(s) into audio. For example, the components may comprise a plurality of cylinders 124 of work implement 120, and each of the operational parameter(s) may represent a position of a respective cylinder 124 of the plurality of cylinders 124. Once the audio is generated, controller 115 may output the audio, generated by the sound-generation algorithm, to an operator in cabin 130. In particular, the audio may be output to and through speaker(s) 134 in cabin 130.

It should be understood that this process of receiving the operational parameter(s), converting those operational parameter(s) into audio, and outputting the audio may all be performed in real time during operation of work machine 100. In an embodiment, the audio is output or streamed continuously, in real time, for at least as long as the operational parameter(s) indicate movement of a component, and this audio stream is modulated according to the value(s) of the operational parameter(s). As used herein, the term “real time” or “real-time” should be understood to mean events that occur simultaneously, as well as events that are temporally spaced apart due to ordinary latencies in processing, communications, memory access, and/or the like.

In an embodiment, the sound-generation algorithm may output the audio in a digital format. In this case, a digital-to-analog converter may be positioned between controller 115 and speaker(s) 134. Thus, the audio would be output to speaker(s) 134 by outputting the audio in the digital format to a digital-to-analog converter that converts the audio to an analog format before being provided to speaker(s) 134.

In an embodiment that provides audio feedback for a plurality of components, the sound-generation algorithm may associate each of the plurality of components with an audio layer that is different from the audio layer associated with at least one other component and potentially all other components. In this case, when the operational parameter(s) are associated with movement of only a single component of work machine 100, the audio may be generated from the audio layer associated with that single component based on the operational parameter(s). On the other hand, when there are two or more operational parameters associated with simultaneous movement of two or more of the plurality of components, the audio may be generated by combining the audio layers associated with the two or more components based on the two or more operational parameters. For example, for each of the operational parameter(s) that reflects a change in the position of a respective cylinder 124, the sound-generation algorithm may incorporate an audio layer associated with that respective cylinder 124 into the audio. More generally, the sound-generation algorithm generates the audio based on the audio layer(s) for every component for which the operational parameter(s) reflect movement.

In an embodiment in which the audio is continuously streamed, the audio may comprise a background audio layer that is output continuously to the operator (e.g., via speaker(s) 134). In this case, as operational parameter(s), reflecting movement of components, are received, additional audio layers, associated with those components, are added to the background audio layer, to thereby modulate the audio stream that the operator hears. The audio layers for different components may comprise white noise, brown noise, pink noise, grey noise, and/or the like. In general, the volume may increase with the amount of movement (e.g., control input or actual sensed movement) that is commanded via input device(s) 132. As an example, lifting the left or right side of blade 126 may add a pink-noise audio layer to the audio stream, and when the end of the range of lift for blade 126 is reached, the pink-noise audio layer may be replaced with a white-noise audio layer, while the volume may be modulated according to the degree of input being commanded. When a side shift to blade 126 is commanded, an audio layer, comprising a sine wave of a specific frequency, may be added to the audio stream, while again the volume is modulated according to the degree of input being commanded. When input device(s) 132 are being used to steer work machine 100, an audio layer (e.g., comprising a clicking or ratcheting noise) for steering may only be added to the audio stream while steering is being commanded, while the centered steering position may be indicated by an audio cue (e.g., a click or ratcheting noise of a different pitch and/or volume). It should be understood that each audio layer may modulate the audio stream according to any audio characteristic (e.g., volume, pitch, timbre, etc.), and different audio layers may modulate different audio characteristics.

In an embodiment, one or more audio layers are synthetically generated. For example, an audio layer may be synthesized from an audio recording of the sound produced by a reference model of the associated component (e.g., actuator 122, cylinder 124, etc.) during movement (e.g., on a sound stage), to produce a synthetic audio layer. Alternatively, an audio layer may be non-synthetic. In this case, the audio layer may be an audio recording of the sound produced by movement of the actual component of work machine 100, during testing of work machine 100 (e.g., on a sound stage in the factory), or real-time audio data captured by a microphone (e.g., in a microphone array) that is configured to capture sound around the component. As another alternative, the audio layer for a component may be synthetically generated in real time based on real-time audio data captured by a microphone (e.g., in a microphone array) that is configured to capture sound around the component. For example, the audio layer may be generated by combining a synthetic audio layer with actual sounds captured by a microphone (e.g., in a microphone array on work machine 100).

In an embodiment that utilizes haptic feedback, the haptic feedback may be generated, instead of or in addition to audio feedback, in a similar or identical manner as the audio feedback. For example, a haptic-generation algorithm may generate haptic feedback by incorporating one or more haptic layers that are each associated with a different component of work machine 100. Each haptic layer may comprise a different vibrational pattern, strength, and/or other haptic characteristic, than one or more other haptic layers. The haptic feedback may be paired with corresponding audio feedback for moving component(s), such as audio that comprises or represents a ratcheting sound.

The operational parameter(s) may be determined based on a control input to input device(s) 132 and/or based on the output of one or more sensors. In an embodiment in which an operational parameter is determined based on a control input, the control input may be mapped to a value of the operational parameter. For example, a position or movement (i.e., change in position) of input device 132 (e.g., a joystick) may be converted into a value of an operational parameter that represents a target position of the component being controlled by the control input, the presence or absence of the movement (e.g., a binary value), the direction of the movement, an amount (e.g., distance) of the movement from the current position to the target position of the component being controlled by the control input, and/or the like. In an embodiment in which an operational parameter is determined based on the output of sensor(s), the value of the operational parameter may comprise or consist of the output of a sensor, be computed from the output of one or more sensors, or otherwise be derived from the output of one or more sensors. Each sensor may be configured to monitor the state, position, audio characteristic, or other attribute of a component (e.g., actuator 122, cylinder 124, blade 126, etc.) of work machine 100.

Regardless of how an operational parameter is determined, the operational parameter may take on a value within a range of possible values. The range of possible values may represent a full range of movement of the component, associated with operational parameter. For example, the range of possible values may represent a discrete or continuous range of positions of an actuator 122 (e.g., valve), cylinder 124, blade 126, or the like. In an embodiment, the sound-generation algorithm may vary at least one characteristic of the audio based on a relative position of the value of an operational parameter within the range of possible values for that operational parameter. For example, the volume, pitch, and/or timbre of a synthetic audio layer, associated with a respective component and incorporated into the audio, may be based on the relative position of the value of the operational parameter, associated with movement of that respective component, within the range of possible values for that operational parameter. More specifically, the audio characteristic of the synthetic audio layer may vary based on the distance of the value of the operational parameter from an end of the range, from a center of the range, and/or the like.

In an embodiment, the sound-generation algorithm may convert the operational parameter(s) into the audio according to one or more operator-specified settings. An operator-specified setting may comprise a value for at least one characteristic of the audio, such as volume, pitch, timbre, and/or the like. Other examples of operating-specified settings include, without limitation, enabling or disabling of the audio feedback, enabling or disabling of one or more features of the audio feedback, a sensitivity of the audio feedback to the movement of input device(s) 132, and/or the like.

In an embodiment, controller 115 may time the outputting of the audio to the operator, based on audio data captured by a microphone that is configured to capture sound around one or more components of work implement 120. For instance, work machine 100 may comprise a microphone array that captures sound around actuator(s) 122, cylinder(s) 124, blade 126, and/or other components of work implement 120, or work machine 100 more generally. Controller 115 may be configured to detect particular sounds (e.g., frequency bands) representing movement of a component of interest, within these audio data, and output the audio to the operator in cabin 130 (e.g., via speaker(s) 134) at a timing that corresponds to the timing at which a particular sound was detected.

In an embodiment, controller 115 may output other audio cues to speaker(s) 134, in addition to or instead of the audio generated by the sound-generation algorithm. For example, controller 112 may output an audio cue to speaker(s) 134 in response to a value of at least one of the operational parameter(s) reaching a limit at one end of a range of possible values for that operational parameter. In this case, the audio cue could comprise or represent the sound of a relief valve. As another example, controller 112 may output an audio cue to speaker(s) 134 in response to a value of at least one of the operational parameter(s) reaching the center of the range of possible values for that operational parameter. Notification of the center of the range, via audio cue, may be especially useful for bidirectional operations, such as steering, articulation, wheel lean, and/or the like.

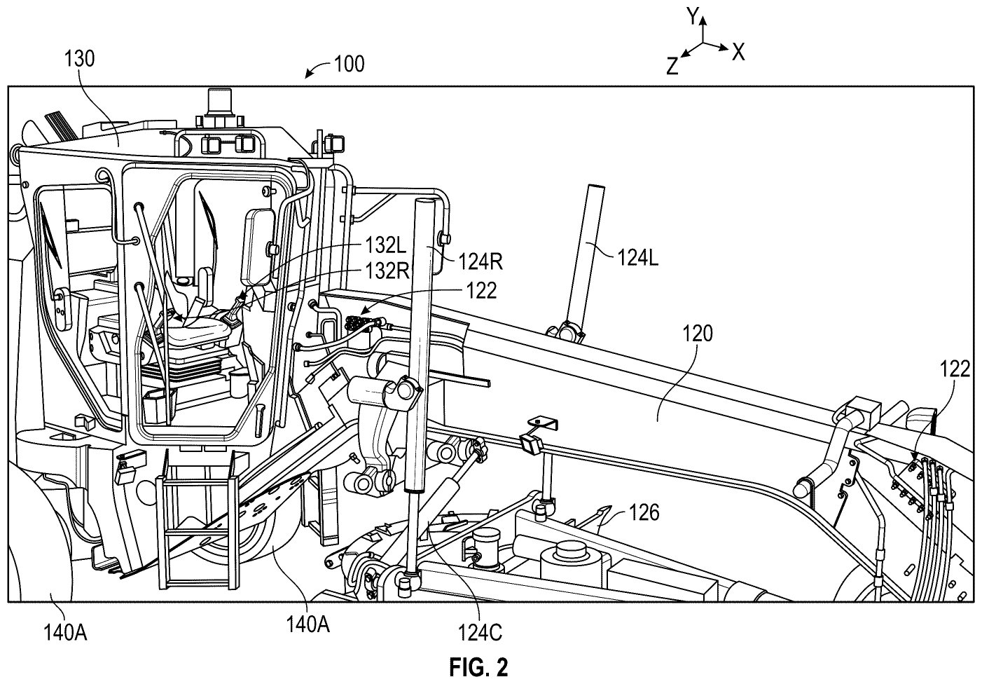

FIG. 2 illustrates example components of work machine 100, according to an embodiment. This embodiment comprises both a right joystick as a right input device 132R and a left joystick as a left input device 132L in cabin 130. In the context of a motor grader, an operator may utilize these input devices 132R and 132L to activate actuators 122, which actuate hydraulic cylinders 124R, 124L, and 124C to extend or contract. For example, right cylinder 124R may lift or lower the right side of blade 126 to rotate blade 126 in the X-dimension, left cylinder 124L may lift or lower the left side of blade 126 to rotate blade 126 in the X-dimension, and central cylinder 124C may control the horizontal position of blade 126. Blade 126 may also be configured to rotate around an axis in the Z-dimension. Accordingly, cylinders 124 provide fine control of blade 126.

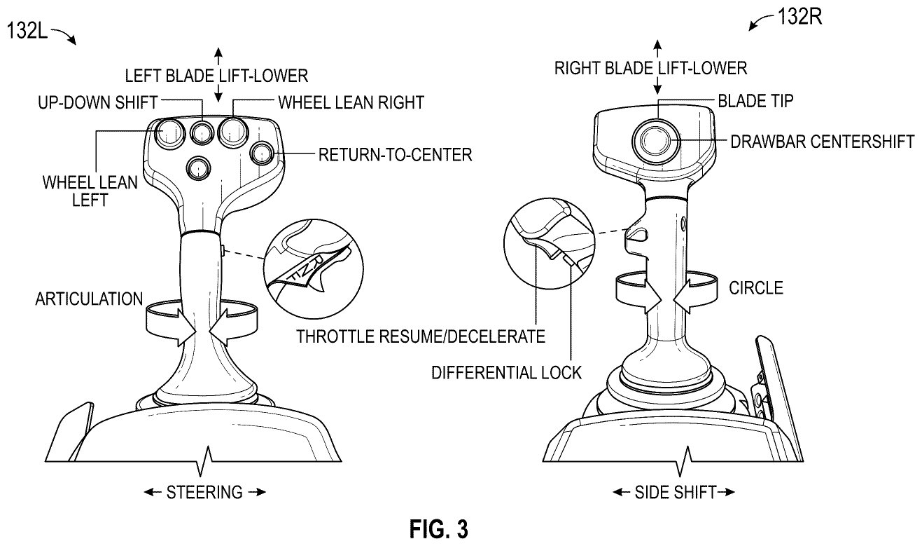

FIG. 3 illustrates example input devices 132 and associated controls, according to an embodiment. In this example, input devices 132 comprise left and right joysticks configured for control of a motor grader as work machine 100. Both left input device 132L and right input device 132R are triple-axis joysticks that move forward and backward, left and right, and rotate around the longitudinal axis.

Notably, the configuration of input devices 132 may result in inadvertent or unintentional control inputs by the operator. For example, an operator intending to only push one of the dual-axis or triple-axis joysticks along a first axis, may unintentionally also push that joystick along the second axis, resulting in an advertent control input along the second axis. In this case, the audio, generated by the sound-generation algorithm, will comprise an audio layer for the movement along the second axis, as well as an audio layer for the movement along the first axis. The output of this composite audio for both axial movements, as opposed to the expected audio for only the first axial movement, will alert the operator of the unintentional control input.

Movement of right input device 132R to the right and left shifts blade 126 right and left, respectively, whereas movement of right input device 132R forward and backwards lowers and raises, respectively, the right side of blade 126. Rotation of right input device 132R, around the longitudinal axis of right input device 132R, controls rotation of blade 126 around an axis in the Y-dimension. In addition, right input device 132R comprises a four-way momentary switch, via which center-shift of the drawbar may be controlled by right and left movements, and lowering and raising of the tip of blade 126 may be controlled by forward and backward movements. Right input device 132R also comprises a trigger for setting the throttle (e.g., throttle lock or cruise control), and a button for activating and deactivating the differential lock.

Movement of left input device 132L to the right and left steers work machine 100 right and left, respectively, whereas movement of left input device 132L forward and backwards lowers and raises, respectively, the left side of blade 126. Rotation of left input device 132L, around the longitudinal axis of left input device 132L, controls articulation of work implement 120 around axis A. In addition, left input device 132L comprises left and rights button for leaning ground-engagement members 140B left and right, respectively, a button for centering the articulated frame of work implement 120, and top and bottom buttons for shifting the gears up and down, respectively. Left input device 132L also comprises a shuttle or forward-neutral-reverse (FNR) switch for switching between forward, neutral, and reverse driving modes.

It should be understood that the illustrated configuration of input devices 132R and 132L is simply one example in the context of a motor grader. In an alternative embodiment, different one or more input devices 132 may be used. In addition, for a different type of work machine 100, the controls available through input device(s) 132 may differ.

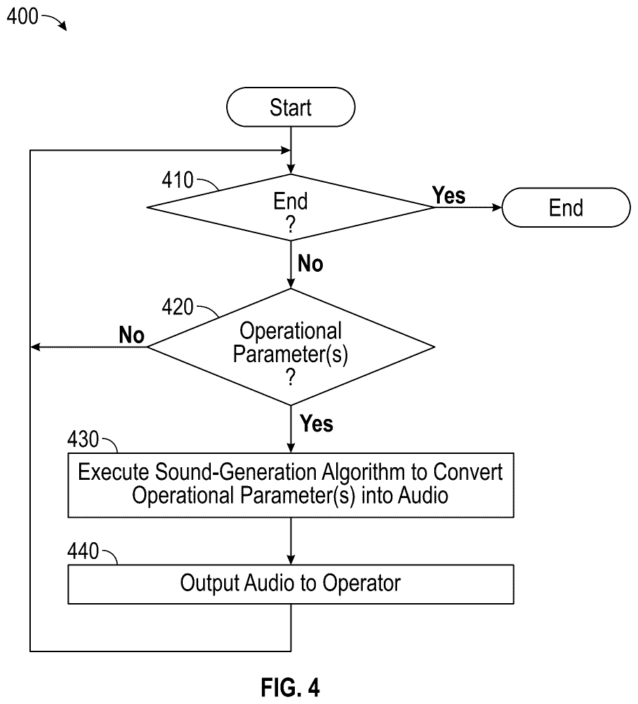

FIG. 4 illustrates a process 400 for providing audio feedback in work machine 100, according to an embodiment. Process 400 may be implemented in real time by controller 115 in a work machine 100, such as a motor grader. While process 400 is illustrated with a certain arrangement and ordering of subprocesses, process 400 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

Subprocess 410 determines whether or not to end process 400. Process 400 may execute continuously, in real time, for as long as work machine 100 is operational (e.g., from the time that work machine 100 is turned on to the time that work machine 100 is shut down). Alternatively or additionally, process 400 may be toggled on and/or off by an operator within cabin 130, via input device(s) 132. Thus, process 400 may end when work machine 100 is shut down and/or when process 400 is toggled off. When determining to end process 400 (i.e., “Yes” in subprocess 410), process 400 may end. Otherwise, until determining to end process 400 (i.e., “No” in subprocess 410), process 400 may proceed to subprocess 420.

Subprocess 420 determines whether or not operational parameter(s) have been received. Operational parameter(s) may be received periodically according to a sampling rate, for example, when the operational parameter(s) are derived from the output of one or more sensors. Alternatively or additionally, operational parameter(s) may be received sporadically, for example, when the operational parameter(s) are derived from control inputs to input device(s) 132. In this case, operational parameter(s) may be received whenever the operator performs a control input to an input device 132. When operational parameter(s) are received (i.e., “Yes” in subprocess 420), process 400 proceeds to subprocess 430. Otherwise, while no operational parameters are received (i.e., “No” in subprocess 420), process 400 returns to subprocess 410.

Each operational parameter may be associated with the movement of one or more components of work machine 100, which are under control of at least one input device 132 (e.g., joystick) in cabin 130. The component(s) may comprise or consist of one or more components of work implement 120, such as actuator(s) 122, cylinder(s) 124, blade 126, and/or the like. In a particular embodiment, each operational parameter represents a position of a respective cylinder 124 of a plurality of cylinders 124 of work implement 120 of work machine 100. Each component, such as each cylinder 124, may be external to cabin 130 of work machine 100, and the position of each component may be controlled by at least one input device 132 in cabin 130. In the context of a motor grader, a component may comprise an actuator 122, such as a valve or cylinder 124, that actuates work implement 120 of the motor grader. In this case, the operational parameter(s) may comprise an operational parameter associated with a position of the valve or cylinder.

As discussed elsewhere herein, at least one operational parameter may be determined based on a control input to at least one input device 132. Alternatively or additionally, at least one operational parameter may be determined based on an output of one or more sensors. In this latter instance, each sensor may be configured to sense one or more of the position of the component (e.g., a respective cylinder 124), an activation of a valve (e.g., solenoid valve, relief valve, etc.), the position of a valve (e.g., solenoid valve, relief valve, etc.), the position of work implement 120, a fluid flow (e.g., a flow of hydraulic fluid), a pressure amount (e.g., hydraulic pressure in a respective cylinder 124), and/or the like. More generally, each sensor may be configured to monitor a state (e.g., activation, position, amount, or other parameter) of a component of work machine 100, and particularly, work implement 120.

Subprocess 430 executes the sound-generation algorithm to convert the operational parameter(s), received in subprocess 420, into audio. In particular, each of a plurality of components of work machine 100, and particularly work implement 120, may be associated with an audio layer. The audio layer that is associated with each component may be different from the audio layer that is associated with at least one of the other components and potentially all of the other components. The sound-generation algorithm may generate the audio by incorporating the audio layer associated with each component, for which the operational parameter(s) represent movement, into the audio. In other words, the audio layers for all moving components are combined to form the audio. For example, for each of the operational parameter(s) that reflects a change in the position of a respective cylinder 124, an audio layer associated with that respective cylinder 124 may be incorporated into the audio. In an embodiment, converting the operational parameter(s) into audio comprises, when the operational parameter(s) are associated with movement of only a single component of work machine 100, generating the audio from the audio layer associated with that single component based on the operational parameter(s), and when the operational parameter(s) comprise two or more operational parameters associated with simultaneous movement of two or more of the plurality of components, generating the audio by combining the audio layers associated with the two or more components based on the two or more operational parameters. In an embodiment in which a continuous audio stream is output to the operator (e.g., via speaker(s) 134), it should be understood that subprocesses 430 may add one or more audio layers to an always-on background audio layer.

The audio layer associated with at least one, and potentially all, of the components, for which audio feedback is to be provided, may be synthetic. Each synthetic audio layer may be synthesized in any suitable manner. In an embodiment, a synthetic audio layer is synthesized from actual sound emitted by the actual respective component or a reference component that represents the actual respective component. For example, in the former instance, the synthetic audio layer may be generated based on audio data captured by a microphone (e.g., in a microphone array) that is configured to capture sound around at least one cylinder 124 or other component of work implement 120. In this case, the synthetic audio layer for a component may represent an augmented or normalized version of the actual sound emitted by that component.

In an embodiment, the value of at least one, and potentially all, of the operational parameter(s) is limited to a discrete or continuous range of possible values. In this case, the audio may be generated based on the relative position of the value of each operational parameter within the respective range of possible values. For example, at least one characteristic of at least one, and potentially all, audio layers in the audio may be based on the relative position of the value of the respective operational parameter(s) within the range of possible values. The characteristic(s) that are varied in this manner may comprise volume, pitch, timbre, and/or the like, and may be varied in proportion to a distance of the position of the value from a reference value in the range of possible values. This reference value may be the value at one end of the range of possible values (e.g., the minimum or maximum value), at the center of the range of possible values, or the like.

Subprocess 440 outputs the audio, generated by the sound-generation algorithm in subprocess 430, to the operator in cabin 130 of work machine 100. In particular, the audio may be output to and through speaker(s) 134 in cabin 130. Thus, the operator is able to hear audio feedback, representing the movement of component(s) of work machine 100, which are external to cabin 130, in real time with control inputs to input device(s) 132, despite the fact that the operator is enclosed by cabin 130, which may be sound-proofed for the operator's comfort.

In an embodiment, subprocess 440 outputs the audio to the operator (e.g., through speaker(s) 134) at a timing that is based on audio data captured by a microphone (e.g., in a microphone array) that is configured to capture sound around one or more of the components (e.g., cylinders 124). In other words, controller 115 may be configured to receive audio data captured by the microphone, monitor the audio data to detect particular sounds (e.g., frequency bands) representing movement of a component of interest, within these audio data, and output the audio to the operator in cabin 130 (e.g., via speaker 134) at a timing that corresponds to the timing at which a particular sound was detected.

In an embodiment, one or more audio cues may be output to the operator (e.g., through speaker(s) 134), in addition to or instead of the audio generated by the sound-generation algorithm, based on a value of an operational parameter. For example, a first audio cue may be output to speaker 134 in response to the value of at least one operational parameter reaching a limit at one end (e.g., the minimum and/or maximum value) of the range of possible values for that operational parameter. As another example, a second audio cue may be output to speaker 134 in response to a value of at least one operational parameter reaching a center of a range of possible values for that operational parameter.

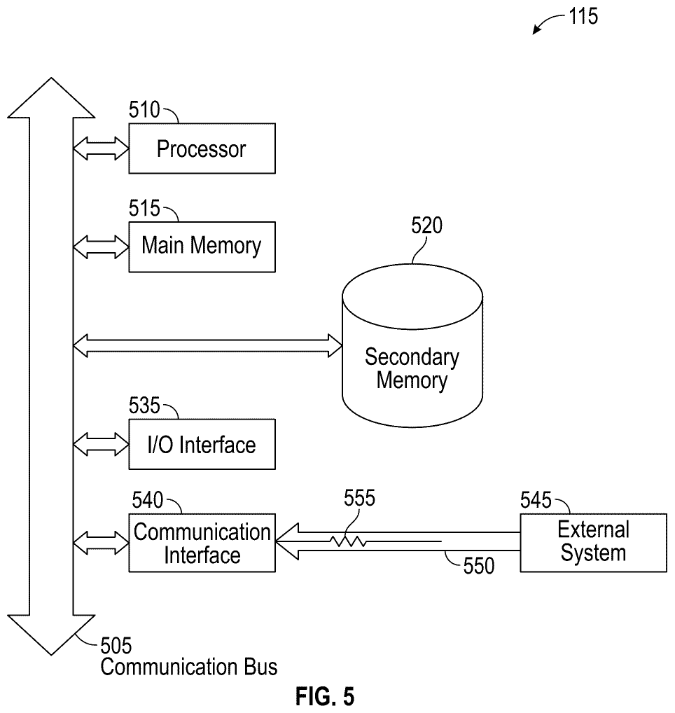

FIG. 5 illustrates an example controller 115 for implementing a process for providing audio feedback in work machine 100, according to an embodiment. Controller 115 may implement process 400. As mentioned elsewhere herein, controller 115 may comprise or consist of an electronic control unit (ECU) within work machine 100.

Controller 115 may comprise one or more processors 510. Processor(s) 510 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 510. Examples of processors which may be used with controller 115 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 510 may be connected to a communication bus 505. Communication bus 505 may include a data channel for facilitating information transfer between storage and other peripheral components of controller 115. Furthermore, communication bus 505 may provide a set of signals used for communication with processor 510, including a data bus, address bus, and/or control bus (not shown). Communication bus 505 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

Controller 115 may comprise main memory 515. Main memory 515 provides storage of instructions and/or other data for software executing on processor 510. It should be understood that instructions stored in the memory and executed by processor 510 may be written and/or compiled according to any suitable language, including without limitation C/C++, Java, JavaScript, Perl, Python, Visual Basic, .NET, and the like. Main memory 515 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Controller 115 may comprise secondary memory 520. Secondary memory 520 is a non-transitory computer-readable medium having instructions and/or other data for software stored thereon. In this description, the term “computer-readable medium” is used to refer to any non-transitory computer-readable storage media used to provide computer-executable code and/or other data to or within controller 115. The computer software stored on secondary memory 520 is read into main memory 515 for execution by processor 510. Secondary memory 520 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Controller 115 may comprise an input/output (I/O) interface 535. I/O interface 535 provides an interface between one or more components of controller 115 and one or more input and/or output devices. For example, I/O interface 535 may receive the output of one or more sensors (e.g., as described elsewhere herein), and/or output control signals to one or more components of work machine 100 (e.g., one or more actuators 122).

Controller 115 may comprise a communication interface 540. Communication interface 540 allows software to be transferred between controller 115 and external devices, networks, or other information sources and/or destinations. For example, instructions and/or other data may be transferred to controller 115, over one or more networks, from a network server via communication interface 540. Examples of communication interface 540 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing controller 115 with a network or another computing device. Communication interface 540 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 540 is generally in the form of electrical communication signals 555. These signals 555 may be provided to communication interface 540 via a communication channel 550 between communication interface 540 and an external system 545. In an embodiment, communication channel 550 may be a wired or wireless network, or any variety of other communication links. Communication channel 550 carries signals 555 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 515 and/or secondary memory 520. Computer-executable code can also be received from an external system 545 via communication interface 540 and stored in main memory 515 and/or secondary memory 520. Such computer-executable code, when executed by processor(s) 510, may enable controller 115 to perform the various functions of the disclosed embodiments, including, for example, process 400.

### INDUSTRIAL APPLICABILITY

It is often necessary for an operator to have fine control of a work implement 120 of a work machine 100. For example, when grading a ground surface, proper control of the blade height is critical. However, fine control of work implement 120 requires feedback to the operator of work machine 100.

With the introduction of electromechanical input devices 132 and sound-proofed cabins 130, it has become difficult for operators, within cabin 130, to receive audio or vibrational feedback from the components of work implement 120. Thus, operators of modern work machines 100 have to rely primarily on visual feedback for the control of components of work implement 120 (e.g., blade 126 of a motor grader). While a visual indicator (e.g., attached to cylinders 124) could be used to aid the operator in understanding the motion of components, in the absence of audio feedback, the operator must still rely on visual feedback.

Disclosed embodiments re-introduce audio feedback into cabin 130 using a sound-generation algorithm to generate the audio. In particular, controller 115 monitors one or more operational parameters associated with movement of component(s) of work machine 100, and particularly, of work implement 120 of work machine 100, as an operator controls the component(s) via input device(s) 132 in cabin 130. For example, controller 115 may monitor the positions of actuators 122, cylinders 124, or other components of work implement 120. In real time with this monitoring of the operational parameter(s), controller 115 executes a sound-generation algorithm to convert the operational parameter(s) into audio, for example, by combining audio layers associated with the components for which the operational parameter(s) reflect movement. Controller 115 outputs the generated audio to the operator, for example, via speaker(s) 134 in cabin 130. This synthetic audio feedback reduces or eliminates the discrepancy between the actual control inputs and the operator's perceived inputs.

The audio may be output continuously, during operation of work machine 100, and continually modulated by the sound-generation algorithm in real time to reflect the component(s) that are moving at any given time, such that the operator is able to make fine adjustments to work implement 120 (e.g., the position of blade 126) without constant visual observation. This improves spatial awareness and safety around work machine 100.

In addition, since the audio comprises a different audio layer for the movement of each component, the operator can be informed of unintentional control inputs. This is of particular benefit when input device(s) 132 comprise a device with multiple axes, such as a dual-axis or triple-axis joystick. For example, when the operator pushes the joystick along a first axis, the operator may unintentionally and simultaneously push the joystick along the second axis. In this case, the sound-generation algorithm will output audio representing a composite of at least one first audio layer associated with the component that is actuated by the intentional input and at least one second audio layer associated with the component that is actuated by the unintentional input. Advantageously, the output of the second audio layer(s) will alert the operator of the unintentional control input.

Notably, a combination of microphone(s), configured to capture sound around the components for which audio feedback is to be provided, and speaker(s) 134, could be used to provide the audio feedback. In this case, the sound, captured by the microphone(s), outside cabin 130, may be relayed through speaker(s) 134 in cabin 130, such that the operator is able to hear the actual external sounds as they occur. However, in an embodiment, synthesized audio (e.g., in discrete audio layers) is used, instead of the actual external sounds. Advantageously, this use of synthesized audio provides greater flexibility in how the audio feedback is provided to the operator.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of work machine. Hence, although the present embodiments are, for convenience of explanation, depicted and described as being implemented in a motor grader, it will be appreciated that it can be implemented in various other types of work machines in which it may otherwise be difficult for the operator to hear or feel the movement of components (e.g., in which electromechanical controls are used, the cabin is sound-proofed, etc.), and in various other systems and environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. A method comprising using at least one hardware processor in a controller within a motor grader to:
receive one or more operational parameters, wherein each of the one or more operational parameters represents a position of a respective cylinder of a plurality of cylinders of a work implement of the motor grader, wherein each of the plurality of cylinders is external to a cabin of the motor grader, and wherein the position of each of the plurality of cylinders is controlled by at least one input device in the cabin;
execute a sound-generation algorithm that converts the one or more operational parameters into audio by, for each of the one or more operational parameters that reflects a change in the position of the respective cylinder, incorporating a synthetic audio layer associated with that respective cylinder into the audio; and
output the audio to an operator in the cabin.

2. The method of claim 1, wherein at least one of the one or more operational parameters is determined based on a control input to the at least one input device.

3. The method of claim 1, wherein at least one of the one or more operational parameters is determined based on an output of a sensor.

4. The method of claim 3, wherein the sensor is configured to sense one or more of the position of the respective cylinder, an activation of a solenoid valve, an activation of a relief valve, a position of a valve, a position of the work implement, a fluid flow, or a pressure amount.

5. The method of claim 1, wherein the audio is output through at least one speaker in the cabin.

6. The method of claim 1, wherein the synthetic audio layer associated with at least one of the plurality of cylinders is generated based on audio data captured by at least one microphone that is configured to capture sound around the at least one cylinder.

7. The method of claim 1, wherein the audio is output to the operator at a timing that is based on audio data captured by at least one microphone that is configured to capture sound around one or more of the plurality of cylinders.

8. The method of claim 1, wherein a pitch of at least one synthetic audio layer that is incorporated into the audio is based on a relative position of a value of at least one of the one or more operational parameters within a range of possible values of that at least one operational parameter.

9. A method comprising using at least one hardware processor in a controller within a work machine to, in real time:
receive one or more operational parameters associated with movement of at least one component of the work machine, external to a cabin of the work machine, under control of at least one input device in the cabin;
execute a sound-generation algorithm that converts the one or more operational parameters into audio; and
output the audio to at least one speaker in the cabin.

10. The method of claim 9, wherein the at least one input device comprises a joystick.

11. The method of claim 9, wherein the sound-generation algorithm associates each of a plurality of components of the work machine, including the at least one component, with an audio layer that is different from the audio layer associated with at least one other one of the plurality of components, and wherein converting the one or more operational parameters into audio comprises:
when the one or more operational parameters are associated with movement of only a single component of the work machine, generating the audio from the audio layer associated with that single component based on the one or more operational parameters; and
when the one or more operational parameters are two or more operational parameters associated with simultaneous movement of two or more of the plurality of components, generating the audio by combining the audio layers associated with the two or more components based on the two or more operational parameters.

12. The method of claim 9, wherein the sound-generation algorithm converts the one or more operational parameters into the audio according to one or more operator-specified settings, and wherein the one or more operator-specified settings comprise a value for at least one characteristic of the audio.

13. The method of claim 9, wherein the one or more operational parameters are received from one or more sensors that are each configured to monitor a state of a component of the work machine.

14. The method of claim 9, wherein the work machine is a motor grader, wherein the at least one component comprises a valve or cylinder that actuates a work implement of the motor grader, and wherein the one or more operational parameters comprise an operational parameter associated with a position of the valve or cylinder.

15. The method of claim 9, further comprising using the at least one hardware processor of the controller to, in response to a value of at least one of the one or more operational parameters reaching a limit at one end of a range of possible values for the at least one operational parameter, output an audio cue to the at least one speaker.

16. The method of claim 9, further comprising using the at least one hardware processor of the controller to, in response to a value of at least one of the one or more operational parameters reaching a center of a range of possible values for the at least one operational parameter, output an audio cue to the at least one speaker.

17. The method of claim 9, wherein the sound-generation algorithm varies at least one characteristic of the audio based on a relative position of a value of at least one of the one or more operational parameters within a range of possible values of that at least one operational parameter.

18. A work machine comprising:
a machine body;
a cabin comprising at least one joystick and at least one speaker;
a work implement comprising a plurality of components;
a controller configured to, in real time with movement of one or more of the plurality of components under control of the at least one joystick,
receive one or more operational parameters associated with the movement of the one or more components,
execute a sound-generation algorithm that converts the one or more operational parameters into audio, wherein the sound-generation algorithm associates each of the plurality of components with an audio layer that is different from the audio layer associated with at least one other one of the plurality of components, and wherein converting the one or more operational parameters into audio comprises incorporating the audio layer associated with each of the plurality of components, for which the one or more operational parameters represent movement, into the audio, and
output the audio to the at least one speaker.

19. The work machine of claim 18, wherein the work machine is a motor grader, wherein the plurality of components comprise a plurality of cylinders, and wherein each of the one or more operational parameters represents a position of a respective cylinder of the plurality of cylinders.

20. The work machine of claim 18, wherein each of the audio layers is synthetically generated.
